(19) United States
(12) Patent Application Publication
(10) Pub. No.: US 2026/0127976 A1
(43) Pub. Date: May 7, 2026

(54) Method to SUCCEED-Model for Students' Success Through Parental Involvement

(71) Applicant: Ella Delores Davis, Quitman, LA (US)

(72) Inventor: Ella Delores Davis, Quitman, LA (US)

(21) Appl. No.: 18/938,066

(22) Filed: Nov. 5, 2024

(51) Int. Cl. G09B 19/00; G06Q 50/20

(52) U.S. Cl. CPC G09B 19/00; G06Q 50/205

(57) ABSTRACT

The invention, Method to SUCCEED—Model for Students' Success through Parental Involvement, is a new department/office to support parents to help their child succeed. The components in this new department/office include: the office/setup with mission statement, job description of SUCCEED personnel, SUCCEED assistants to include volunteers, and stakeholders, letters to inform the public about SUCCEED, assistance that can be acquired through the SUCCEED office, SUCCEED Plan with a SUCCEED Plan Form, SUCCEED criteria for awards, as well as certificates for SUCCEED awards. In conclusion and with emphasis, the involvement of parents in a child's life is one of the primary indicators of future success for the child in school, activities, and life in general. This invention will support that crucial parental involvement; therefore, that is fundamentally and predominately why a Utility Patent should be considered and granted for this invention, Method to SUCCEED—Model for Students' Success Through Parental Involvement.

### CROSS-REFERENCE TO RELATED APPLICATIONS

This application claims the benefit of Provisional Patent Application Ser. No. 63/597,133 filed Nov. 11, 2023 by present inventor, Ella Delores Davis.

### BACKGROUND OF INVENTION

The field of the art for which this invention pertains are the fields of education & business.

Since the inception of education, the role of parent(s) has been important. Historically, problems exist for the parents as well as the child as a result of the lack of parental involvement in their child's education and activities. Those known problems include the following:
Parental lack of involvement in their child's education
Lack of communication between the parent(s) and school personnel
Lack of transportation for the parents to go to school to attend needed activities
Lack of transportation to go to school if the child misses the school bus
Failure to succeed at students' ability level as a result of the lack of resources from home
Inconsistently or not completing home assignments
Lack of access to electronic devices
Lack of access to the internet
Lack of needed school supplies
Failure to acquire needed school attire
Failure to have a SUCCEED Plan
Inability for agencies, groups, and organizations to have student participation due to lack of access to services and items needed for participation from parents

Because of the parent's inability to provide for the child adequately in the suggested areas above as well as in other areas, the child suffers academically as well as in other areas of their social/emotional development whether they are in school, or a recipient of services from agencies, groups, or organizations. A comprehensive add on department in school systems, agencies, groups, and organizations to take care of these needs has not been developed; therefore, a proposed add on department/office to support and foster students' success through parental involvement particularly, the Method to SUCCEED—Model for Students' Success Through Parental Involvement is submitted for consideration for a Utility Patent.

### BRIEF SUMMARY OF THE INVENTION

### Statement of the Object of the Invention

Protection is being sought for the invention, Method to SUCCEED—Model for Students' Success Through Parental Involvement which is a new add on department/office for school systems, agencies, groups, and organizations to provide services to parents to eliminate barriers such as the presently existing problems/barriers noted in Background of the Invention in order for parents to get involved in their child's life to help their child succeed. Barriers eliminated would include: lack of transportation, lack of supplies/equipment, inconsistent or failure to communicate with personnel, failure to perform at students' ability level, as well as plan for the future.

The purpose of this invention, Method to SUCCEED—Model for Students' Success Through Parental Involvement, is to eliminate obstacles for parents to be involved in their child's education/activities in order for child to be fully engaged as the child strives for achievement/success.’

### Environment Invention Used In

This invention will be used in school systems, agencies, groups, and organizations for grades levels, Head Start-High School & Beyond.

### BRIEF DESCRIPTION OF VIEWS OF THE DRAWING: (IF ANY) A DESCRIPTION OF THE VIEWS BY SPECIFYING THE NUMBERS OF THE FIGURES

This invention, Method to SUCCEED—Model for Students' Success Through Parental Involvement, relates to the figures listed below:

FIG. 1 is a floor plan for the new department, Method to SUCCEED—Model for Students' Success Through Parental Involvement.

FIG. 2 is a flowchart of the Method to SUCCEED—Model for Students' Success Through Parental Involvement.

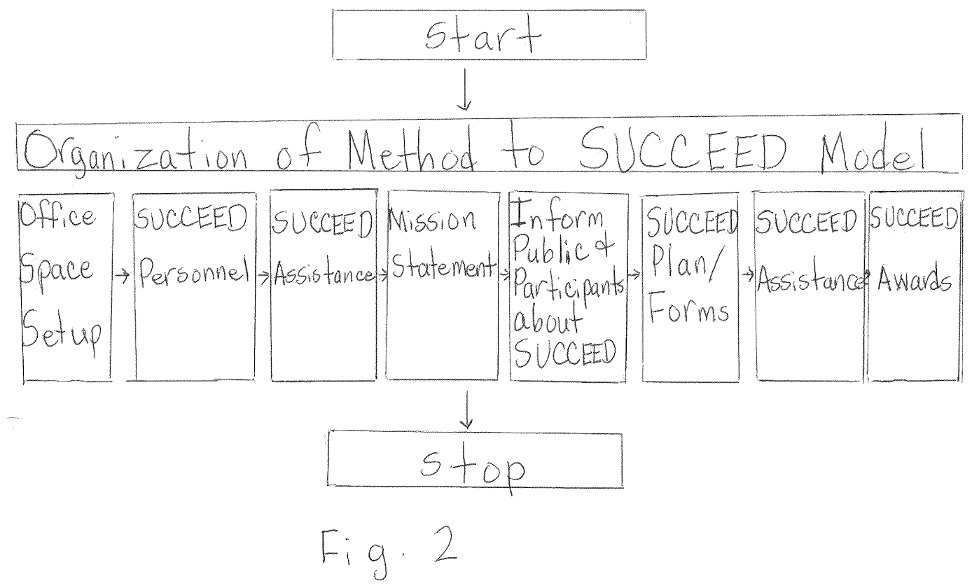

FIG. 3A is the first part of letter to schools in checklist form to parents to be informed about Method to SUCCEED—Model for Students' Success Through Parental Involvement,

FIG. 3B is the second part of letter to schools in checklist form to parents to be informed about Method to SUCCEED—Model for Students' Success Through Parental Involvement,

FIG. 3C is the third part of letter to schools in checklist form to parents to be informed about Method to SUCCEED—Model for Students' Success Through Parental Involvement,

FIG. 3D is the fourth part of letter to schools in checklist form to parents to be informed about Method to SUCCEED—Model for Students' Success Through Parental Involvement.

FIG. 4A is the first part of a letter to schools in checklist and question form to parents to be informed about Method to SUCCEED—Model for Students' Success Through Parental Involvement,

FIG. 4B is the second part of a letter to schools in checklist and question form to parents to be informed about Method to SUCCEED—Model for Students' Success Through Parental Involvement,

FIG. 4C is the third part of a letter to schools in checklist and question form to parents to be informed about Method to SUCCEED—Model for Students' Success Through Parental Involvement,

FIG. 4D is the fourth part of a letter to schools in checklist and question form to parents to be informed about Method to SUCCEED—Model for Students' Success Through Parental Involvement.

FIG. 5A is the first part of a letter to agencies, groups, and organizations in checklist form to parents to be informed about Method to SUCCEED—Model for Students' Success Through Parental Involvement,

FIG. 5B is the second part of a letter to agencies, groups, and organizations in checklist form to parents to be informed about Method to SUCCEED—Model for Students' Success Through Parental Involvement,

FIG. 5C is the third part of a letter to agencies, groups, and organizations in checklist form to parents to be informed about Method to SUCCEED—Model for Students' Success Through Parental Involvement,

FIG. 5D is the fourth part of a letter to agencies, groups, and organizations in checklist form to parents to be informed about Method to SUCCEED—Model for Students' Success Through Parental Involvement.

FIG. 6A is the first part of a letter to agencies, groups, and organizations in checklist and question form to parents to be informed about Method to SUCCEED—Model for Students' Success Through Parental Involvement,

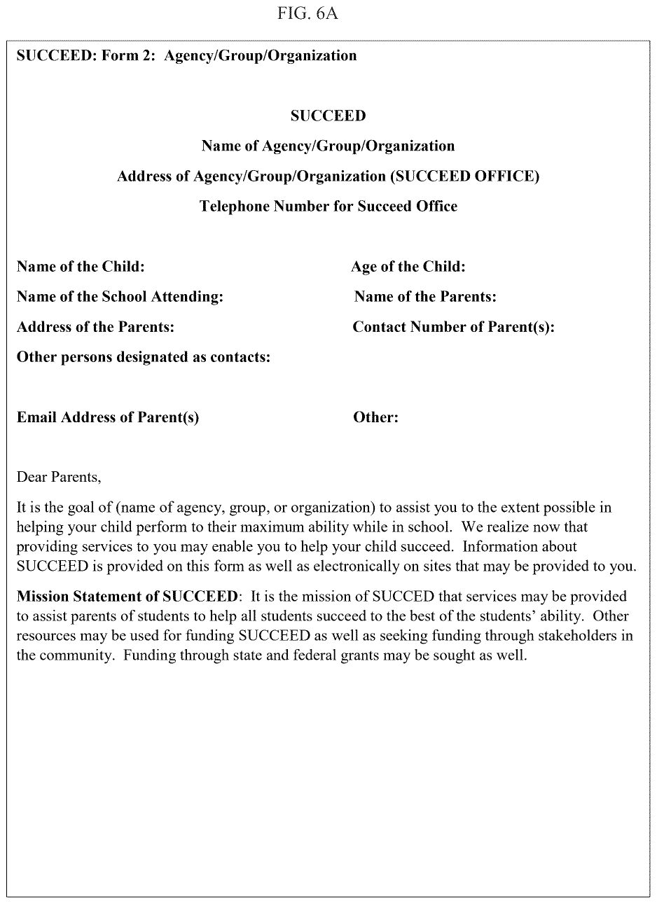

FIG. 6B is the second part of a letter to agencies, groups, and organizations in checklist form to parents to be informed about Method to SUCCEED—Model for Students' Success Through Parental Involvement,

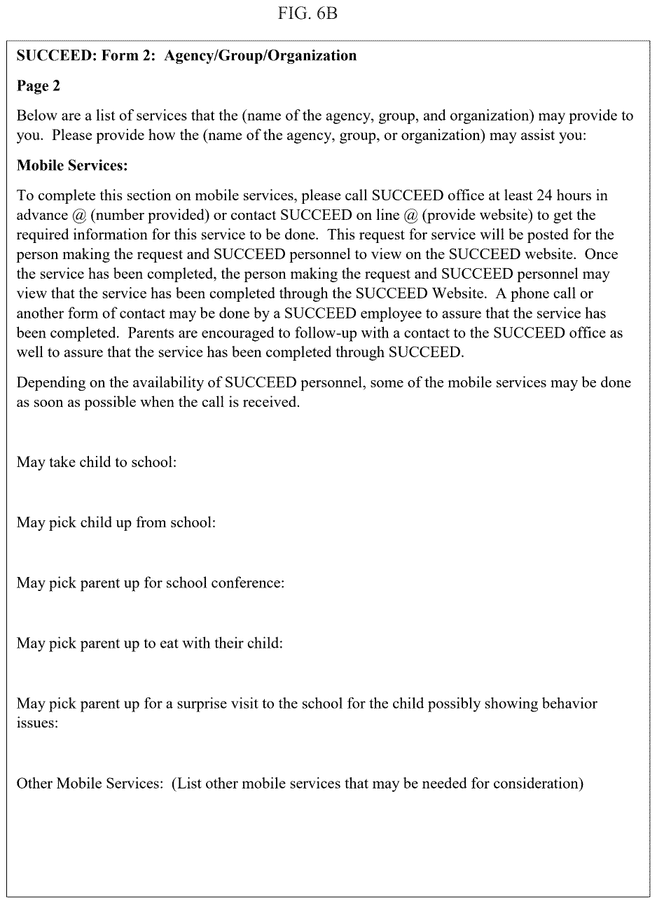

FIG. 6C is the third part of a letter to agencies, groups, and organizations in checklist form to parents to be informed about Method to SUCCEED—Model for Students' Success Through Parental Involvement,

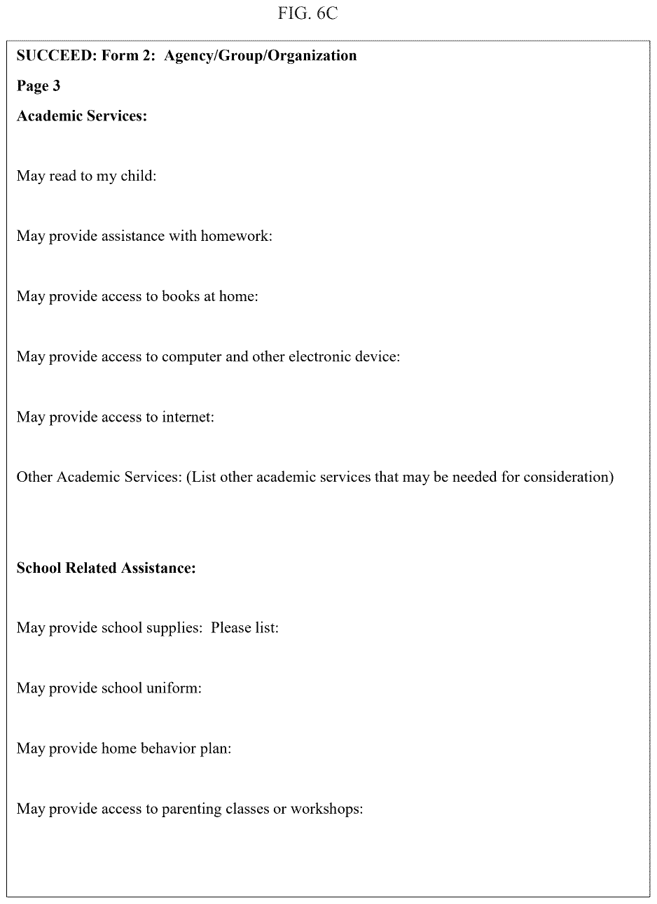

FIG. 6D is the fourth part of a letter to agencies, groups, and organizations in checklist form to parents to be informed about Method to SUCCEED—Model for Students' Success Through Parental Involvement.

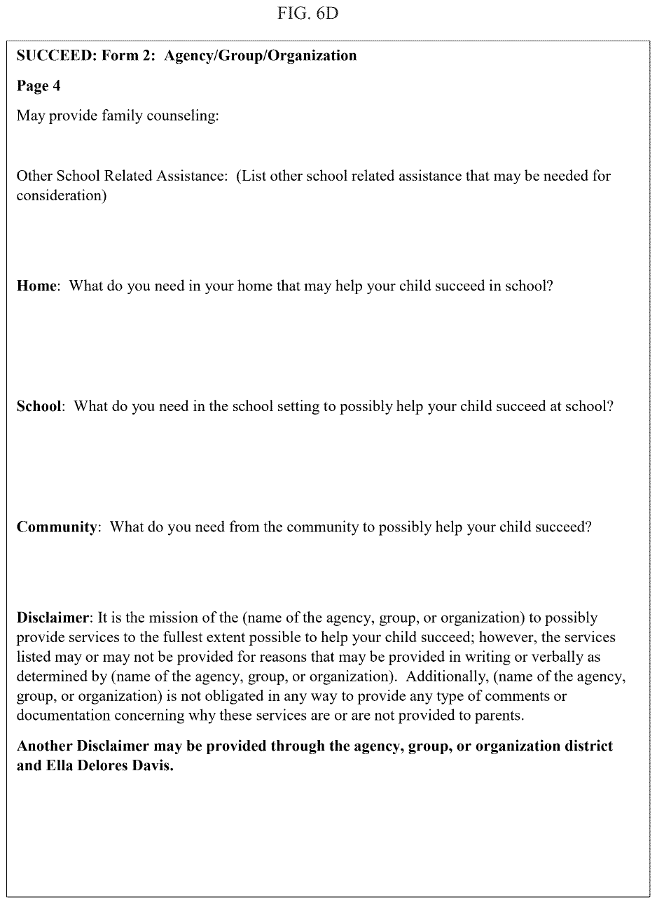

FIG. 7A is the first part of a SUCCEED Plan/Document for participants (schools) noting the need to start thinking about future plans/goals,

FIG. 7B is the second part of a SUCCEED Plan/Document for participants (schools) noting the need to start thinking about future plans/goals,

FIG. 7C is the third part of a SUCCEED Plan/Document for participants (schools) noting the need to start thinking about future plans/goals,

FIG. 7D is the fourth part of a SUCCEED Plan/Document for participants (agencies, groups, organizations) noting the need to start thinking about future plans/goals.

FIG. 7E is the fifth part of a SUCCEED Plan/Document for participants (agencies, groups, organizations) noting the need to start thinking about future plans/goals.

FIG. 7F is the sixth part of a SUCCEED Plan/Document for participants (agencies, groups, organizations) noting the need to start thinking about future plans/goals.

FIG. 8 is a first certificate to award parents, students, volunteers, and stakeholders in schools through Method to SUCCEED—Model for Students' Success Through Parental Involvement.

FIG. 9 is a second certificate to award parents, students, volunteers, and stakeholders in schools through Method to SUCCEED—Model for Students' Success Through Parental Involvement.

FIG. 10 is a third certificate to award parents, students, volunteers, and stakeholders in schools through Method to SUCCEED—Model for Students' Success Through Parental Involvement.

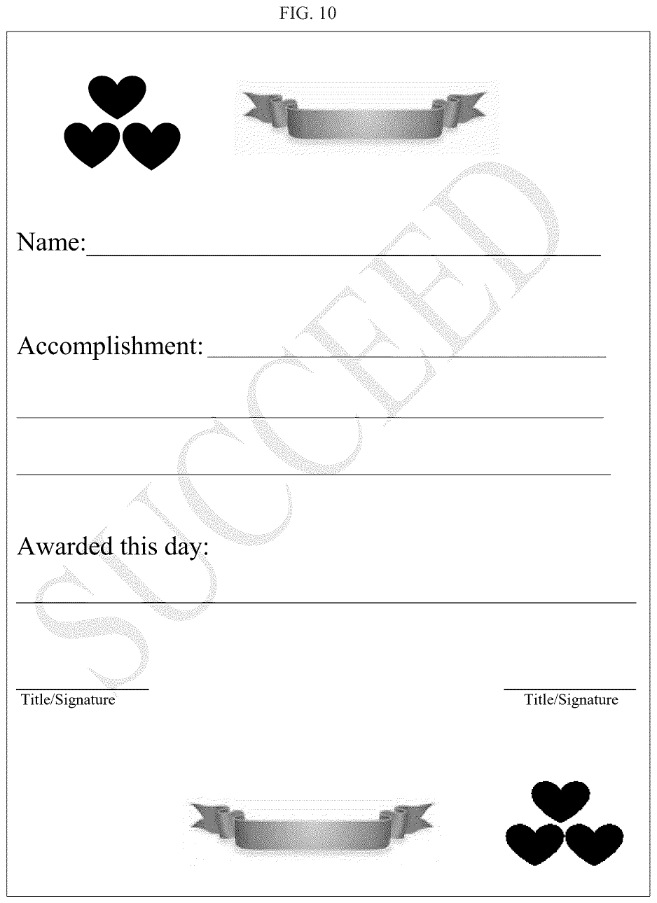

FIG. 11 is a first certificate to award parents, students, volunteers, and stakeholders in agencies, groups, and organizations through Method to SUCCEED—Model for Students' Success Through Parental Involvement.

FIG. 12 a second certificate to award parents, students, volunteers, and stakeholders in agencies, groups, and organizations through Method to SUCCEED—Model for Students' Success Through Parental Involvement.

FIG. 13 is a third certificate to award parents, students, volunteers, and stakeholders in agencies, groups, and organizations through Method to SUCCEED—Model for Students' Success Through Parental Involvement.

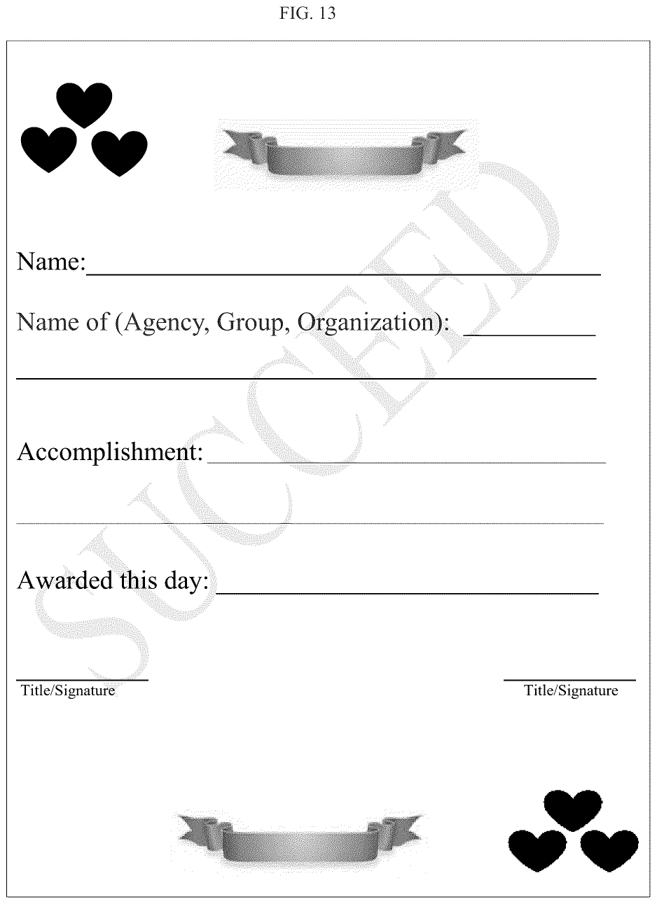

FIG. 14 is a Model for Method to SUCCEED for Students' Success Through Parental Involvement.

### DETAILED DESCRIPTION OF THE INVENTION: DESCRIPTION OF THE INVENTION INCLUDING THE MANNER AND PROCESS OF ITS MAKING AND USE

Office space for this new department/office can vary depending on the size of the school district, agency, group, or organization. With the office space given, I/you can take an office space and set up this new department/office specifically designed to support parents to help their child succeed. I/you would set up the Method to SUCCEED—Model for Students' Success Through Parental Involvement in this manner:

### Display: About the SUCCEED Model

The Method to SUCCEED Model is designed for SUCCEED employees, school community, and stakeholders to provide services to parents of students in order for students to experience success. These services through SUCCEED begin at head start and continues through high school and beyond with the possibility of being applicable for use in other types of agencies, groups, and organizations. The services through Method to SUCCEED—Model for Students' Success Through Parental Involvement may be the link for school districts to work successfully with parents in order for students to experience success.

In order for Method to SUCCEED—Model for Students' Success Through Parental Involvement to be used by other types of organizations other than schools simply apply the Method to SUCCEED Model for Students Success Through Parent Involvement concept to your agency, group, or organization.

### Use of the Word, Parent, for SUCCEED

Parent may refer to one or two persons responsible for the child in this text.

### Organization of Method to SUCCEED—Model for Students' Success Through Parental Involvement

### Display: Mission

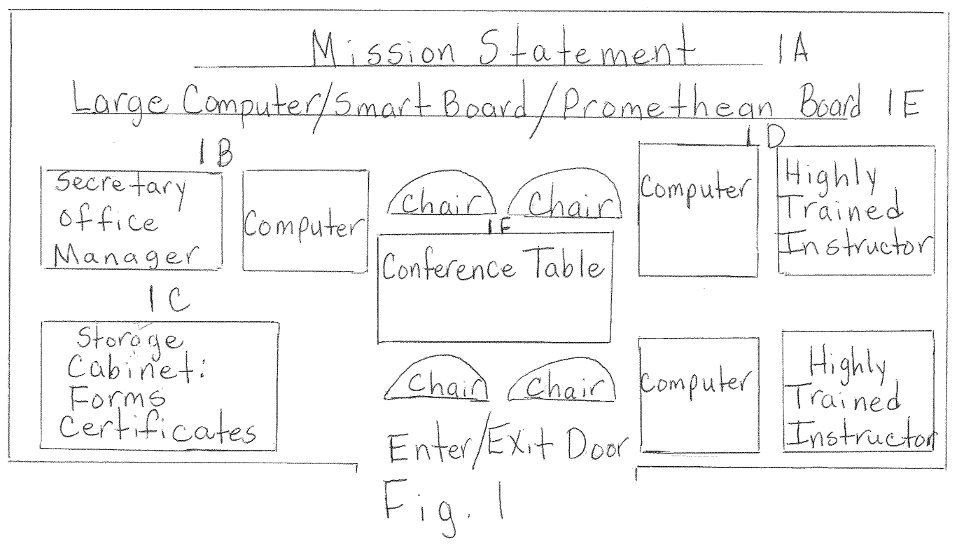

As shown in FIG. 1, the mission 1A for Method to SUCCEED—Model for Students Success Through Parental Involvement is that school systems set up a SUCCEED Department as a part of the school system, and hire SUCCEED personnel specifically to provide services to assist parents in order that they will get involved in their child's education to help their child succeed in school. Through the assistance of Method to SUCCEED—Model for Students' Success Through Parental Involvement, parents will become involved in their child's education.

The mission for Method to SUCCEED—Model for Students Success Through Parental Involvement is for agencies, groups, and organizations is to set up a SUCCEED department. SUCCEED personnel could be hired specifically to provide services to assist parents in order that they will get involved to help their child succeed in the agency, group, or organization.

### Hours

The hours for SUCCEED personnel may be from 6:00 AM-10:00 PM. Personnel hired for this service may be required to work in shifts (Morning or Evening) since the work hours are from 6:00 AM to 10:00 PM—Monday-Friday with the possibility of working on the weekend.

Hours may vary according to the school district, agency, group, or organization.

### Personnel

Personnel titles needed for this new department will include secretary/office manager and highly trained instructor(s).

Two to four personnel may be needed depending on the size of the school district, agency, group, or organization. The number of personnel hired will be determined by the size of the district, agency, group, or organization.

### Secretary/Office Manager: Job Responsibilities

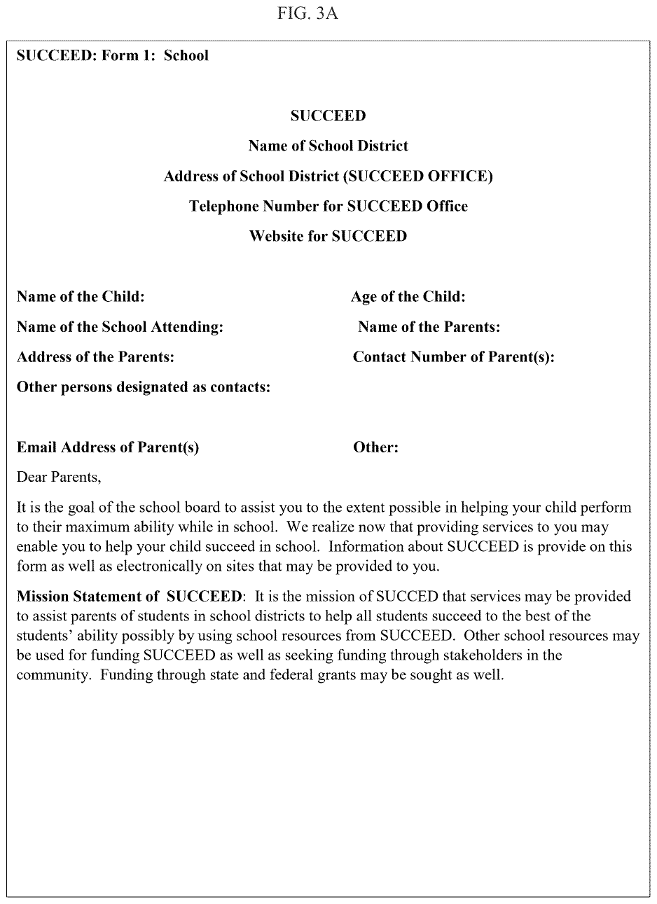

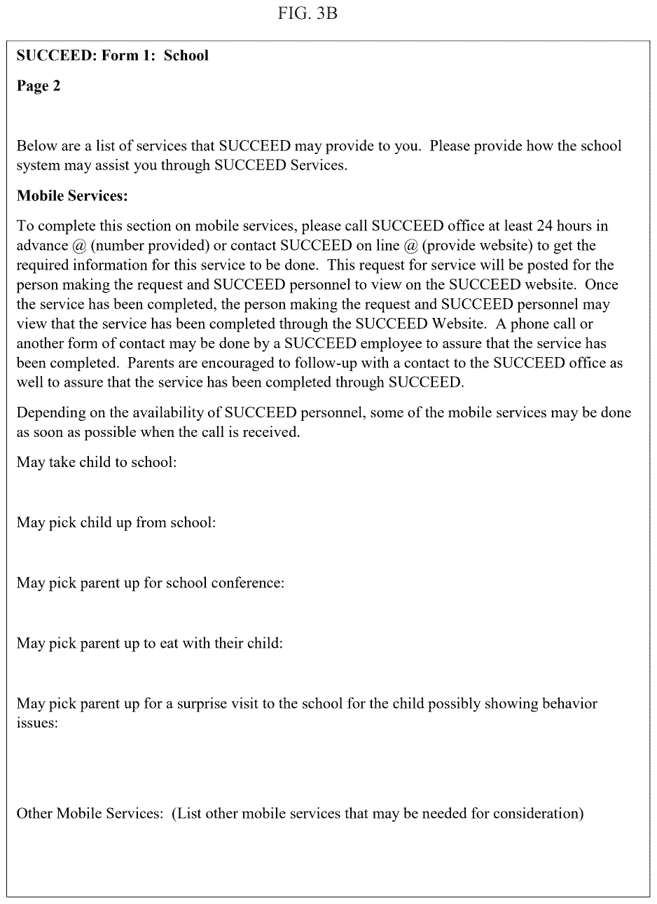

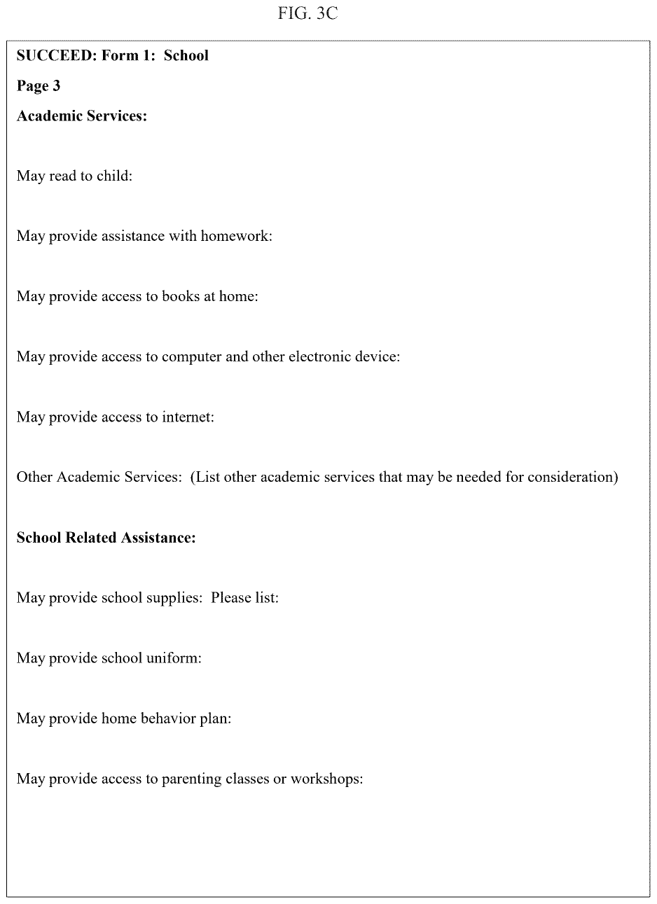

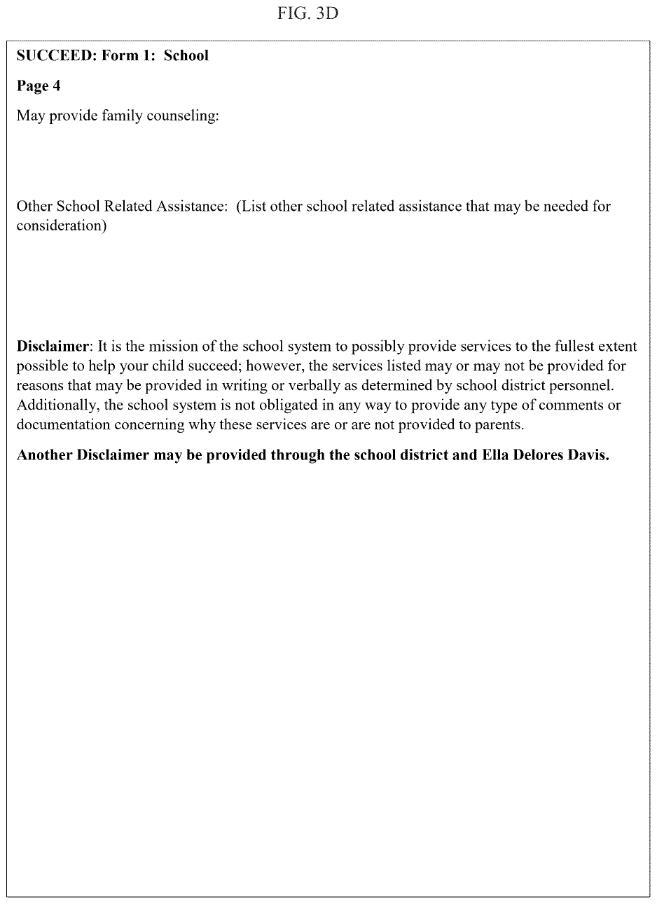

As displayed in FIG. 1, one to two persons 1B may be needed to disseminate SUCCEED forms 3A-3D & 4A-4D as seen in FIGS. 3 & 4, receive SUCCEED forms as they are completed, group the forms according to needs of parents, and receive requests for assistance from parents through SUCCEED via phone or electronically, and document assistance needed electronically. Additionally in the school setting, the secretary/office manager may correspond with parents, seek resources along with central office staff to support the needs of parents listed on SUCCEED form, keep a record of the success of children receiving SUCCEED services, as well as other designated responsibilities. All records will be kept in a locked storage cabinet 1C as shown in FIG. 1.

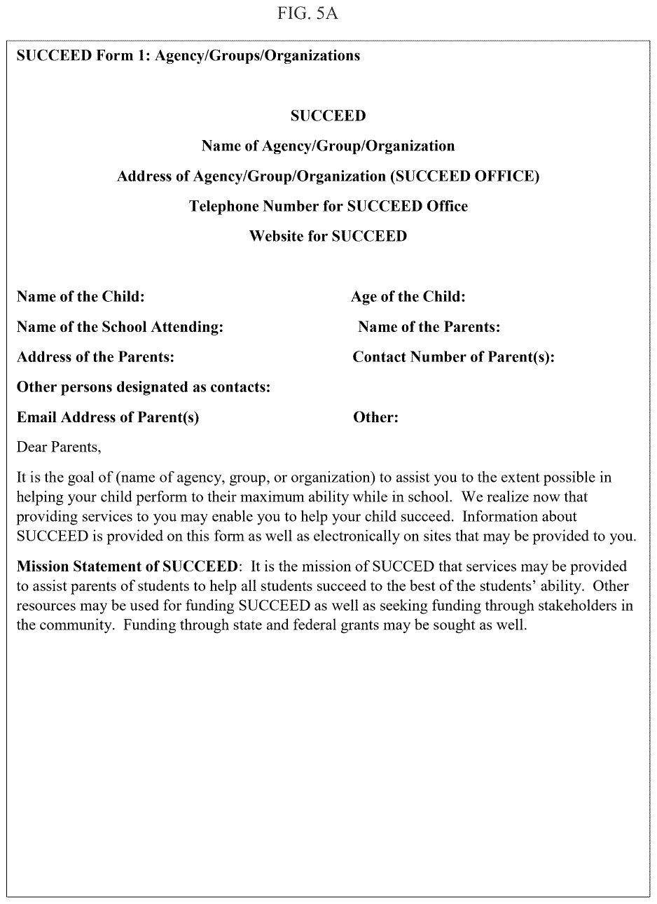

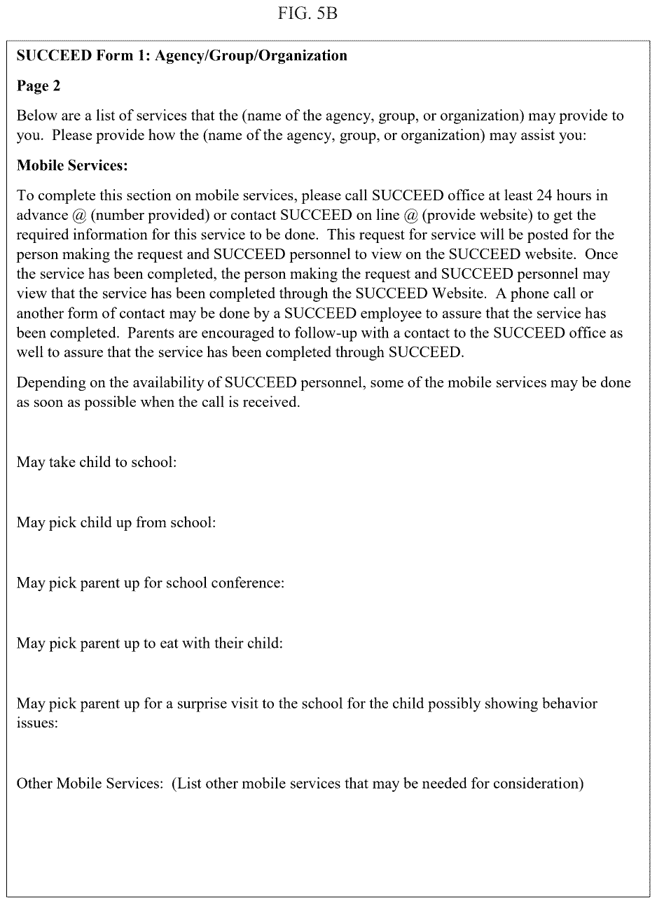

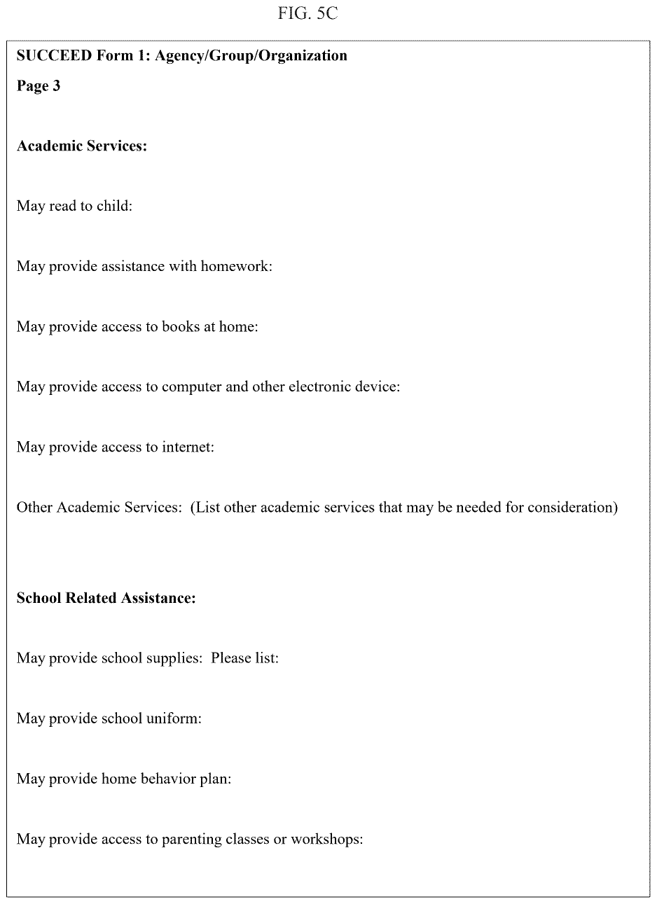

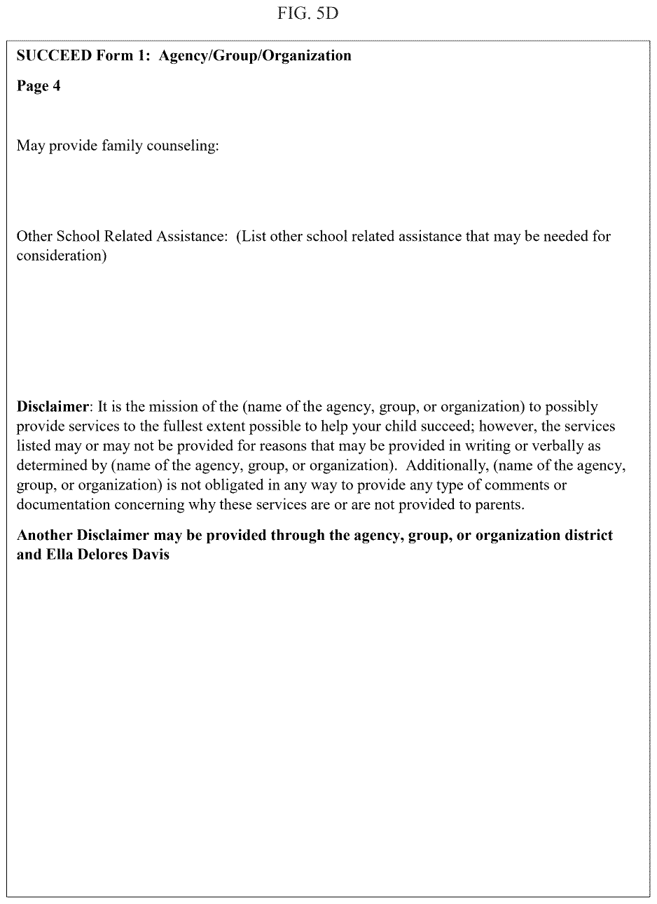

In an agency, group, or organization, the duties of the secretary/office manager would be the same as in the school setting. SUCCEED forms for agencies, groups, and organizations 5A-5D & 6A-6D shown in FIGS. 5 & 6.

### Highly Trained Instructors: Job Responsibilities

As seen in FIG. 1, one to two highly trained instructors 1D may to go out to designated sites in an effort to fulfill the requests made through the SUCCEED office. The car, van, and/or bus may have the word, SUCCEED, written all over it as a way to motivate parents to help their child want to experience success in school, incline the child to want to be successful, and inspire the community to get involved in order that as many children as possible will succeed. Stated simply, the constant visual of SUCCEED written on vehicles as they are seen in the area may solidify the fact that the mindset of the school community and the community in general is geared toward students' success. Additionally, the name of the school district, agency, group, or organization may be written on the car, van, and/or bus designated for SUCCEED. Other duties for the highly trained instructors with permission from the administration may include on line tutoring during the day while students are in class, assisting with homework in the evening, in person or on line, as well as additional duties that may be assigned.

### How to Inform the Public about SUCCEED

May place SUCCEED on the school district's website.

May place SUCCEED on the website for each school in the district.

May place the SUCCEED document in the packet for each student to give to the parent at the beginning of the school year.

School personnel may discuss information about SUCCEED with parents during parent/teacher conferences, and other school meetings.

May place article about SUCCEED in local newspaper.

May place information about SUCCEED on other forms of media deemed appropriate by the school district.

May place information about SUCCEED on media specific to your agency, group or organization

### Procedure for Parents, School Personnel, and School Community to Voluntarily Request Assistance through SUCCEED

May call SUCCEED office.

May use on line website, SUCCEED, set up by the school district which may be connected to each school in the district.

May use on line website specific to your agency, group or organization

### Procedure for Parents for Involuntary Participation in SUCCEED

Administrators in the school districts may decide that all parents of students that have a C average or below must participate in SUCCEED.

Administrators in the school district may decide that all parents regardless of the child's grade point average will participate in SUCCEED.

Groups and organizations may determine the criteria for participation based on academic, emotional, or social needs of the child and/or family.

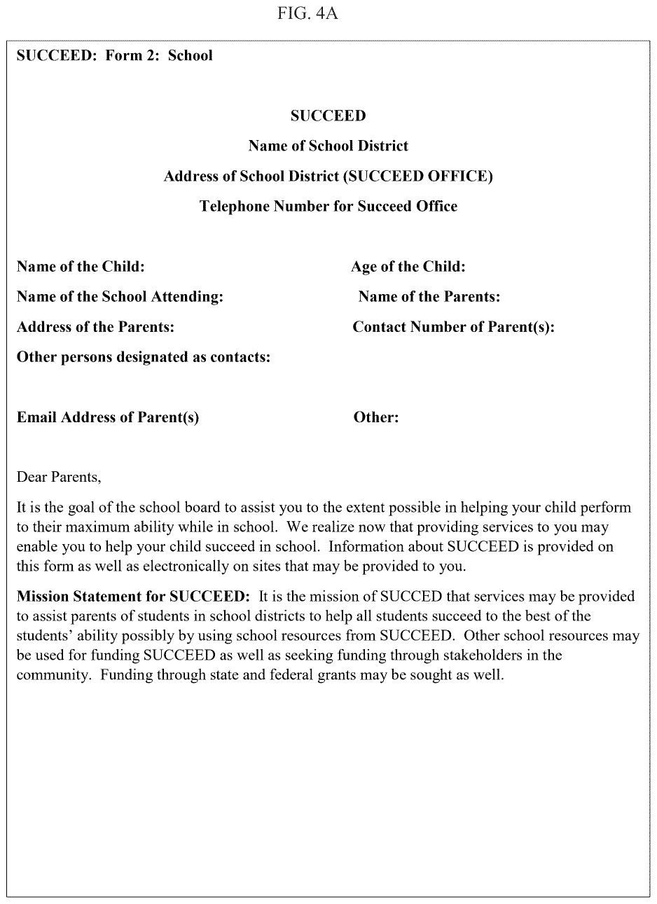

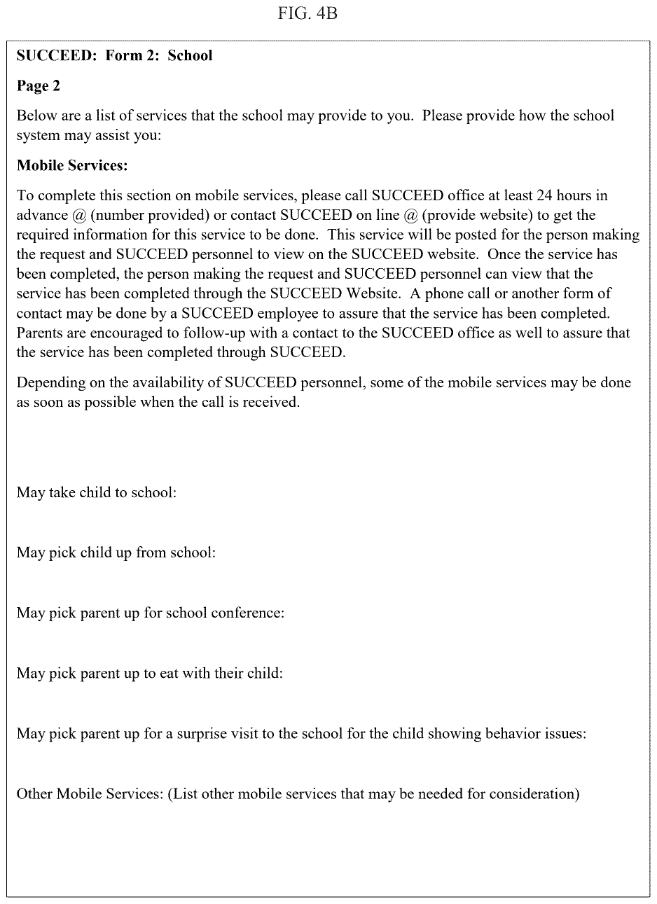

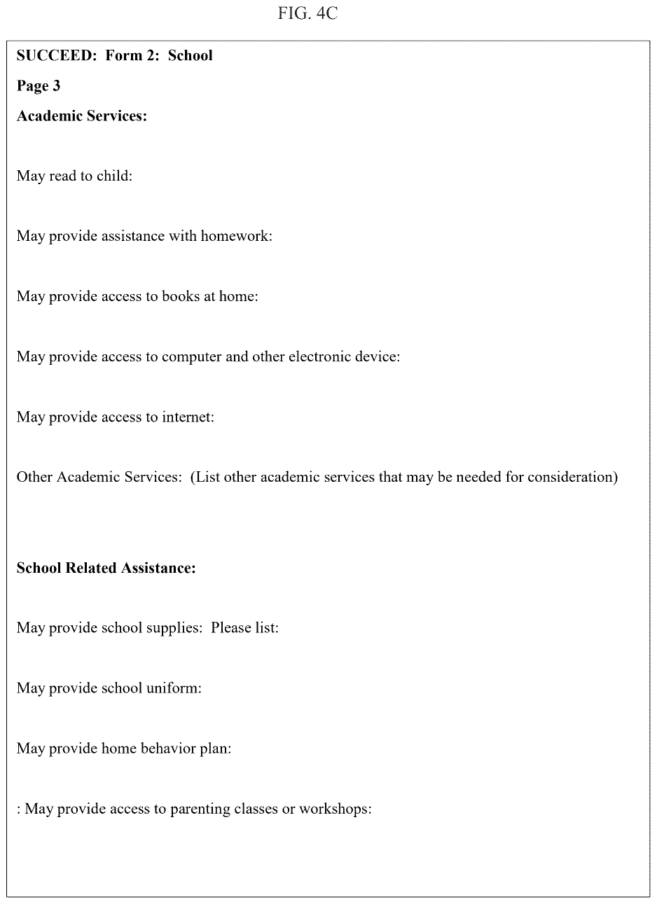

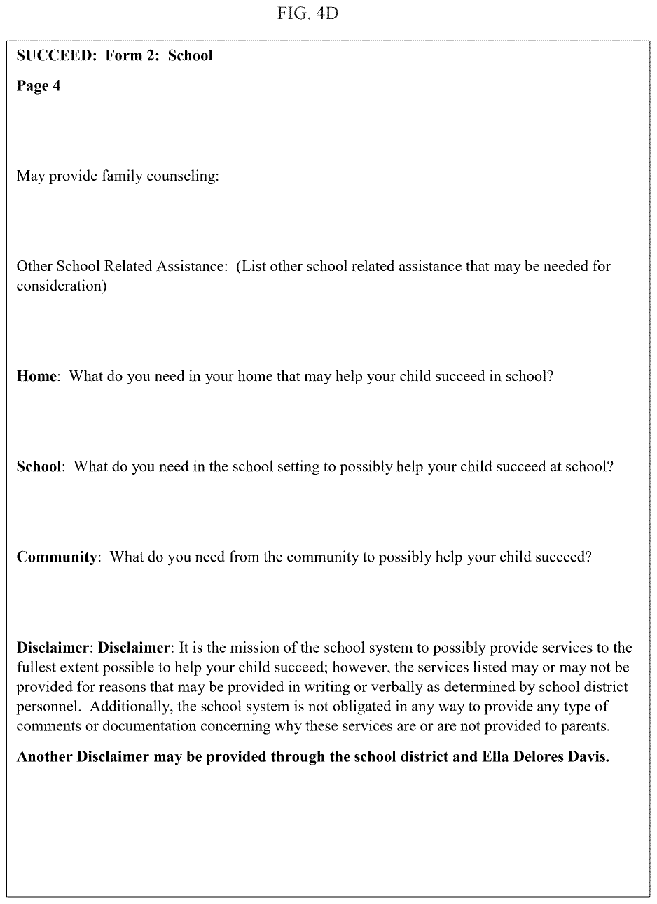

The letters 3A-3D and 4A-4D are used to inform parents about SUCCEED are shown in FIGS. 3 and 4.

The letters used to inform participants from agencies, groups, and organizations about SUCCEED 5A-5D and 6A-6D are shown in FIGS. 5 & 6.

### SUCCEED—Assistance with Homework & Classwork Division

Parents and teachers may be made aware of how to register the child to receive assistance on class work and homework by calling SUCCEED, or by making an appointment on line through the SUCCEED office concerning how the child may receive assistance when completing class work and/or homework.

To the fullest extent possible, assistance may be provided in person with SUCCEED personnel and approved volunteers for SUCCEED. Volunteers may include community leaders as well as anyone that is interested and approved through the school system for providing assistance in helping students to succeed.

The service of providing assistance to students whether on line or in person may be done during the school day provided that personnel from SUCCEED and approved volunteers are available. The teacher may simply inform SUCCEED personnel that this service is needed and provide the needed information for assistance to be received whether electronically or in person.

Assistance may be provided in helping students with homework in person or online 1E as shown in FIG. 1 with personnel through SUCCEED as well as approved volunteers designated by the school district. Sessions for persons to receive assistance on homework may be set up in blocks on line through the SUCCEED website for parents and teachers to see as well as personnel from SUCCEED. Parents should make sure that the child is available to receive assistance.

Another option may be to set up tutoring centers in all neighborhoods or as many neighborhoods as possible in order for students to receive assistance with completing homework with SUCCEED personnel and approved community volunteers.

An additional component of SUCCEED may be to teach parents how to parent as well as how to assist their child with school work, homework, and other needs deemed necessary for the child to experience school success and success in general.

Agencies, groups, and organizations may apply the same techniques suggested for school personnel and the school community in assisting parents when supporting their child.

### SUCCEED—Drop-In Division

### Mission

The Drop-In Division of SUCCEED is for parents to drop in to the SUCCEED office and sit down at the conference table 1F as visible in FIG. 1 or make contact electronically to discuss alternatives to try to keep their child in school should they realize that their child may be at risk of dropping out of school. Additionally, students that realize that they are considering dropping out of school may contact the SUCCEED office as well as long as guidelines are followed concerning age restraints.

SUCCEED office personnel may support students using available resources to stay in school and SUCCEED.

Leaders in agencies, groups and organizations may use this service as long as guidelines are followed concerning the age of the child or participant in SUCCEED.

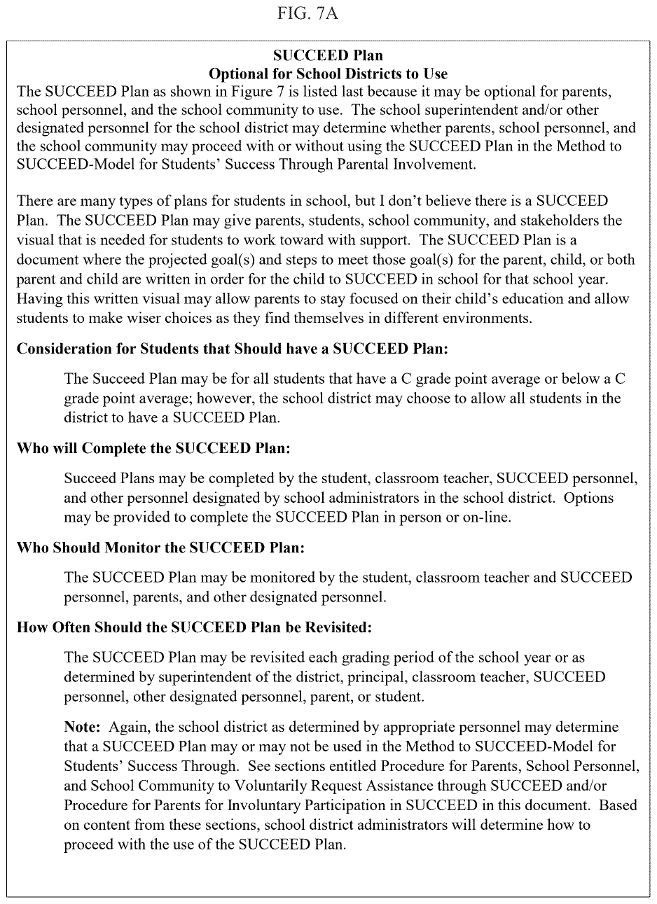

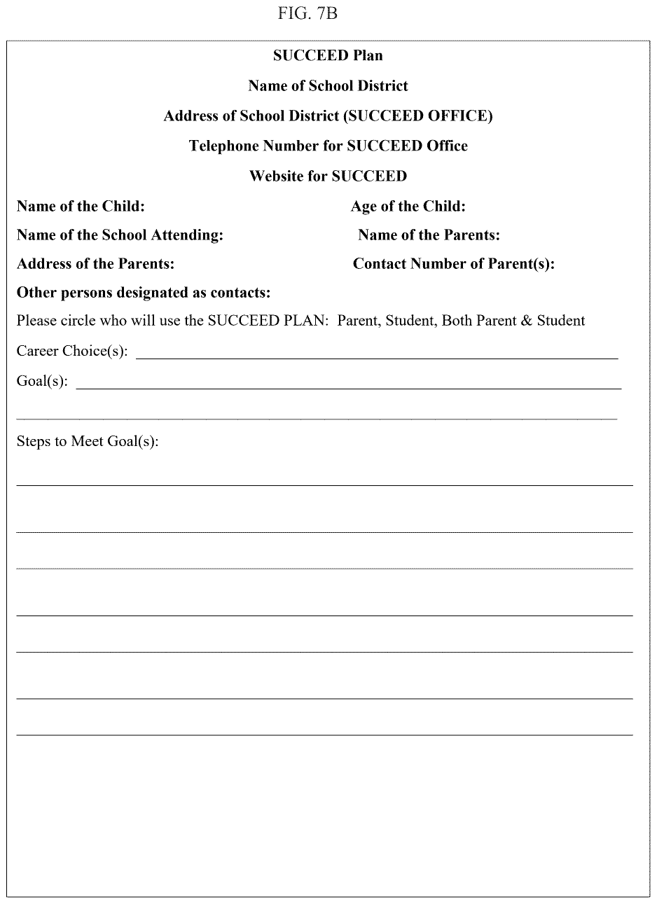

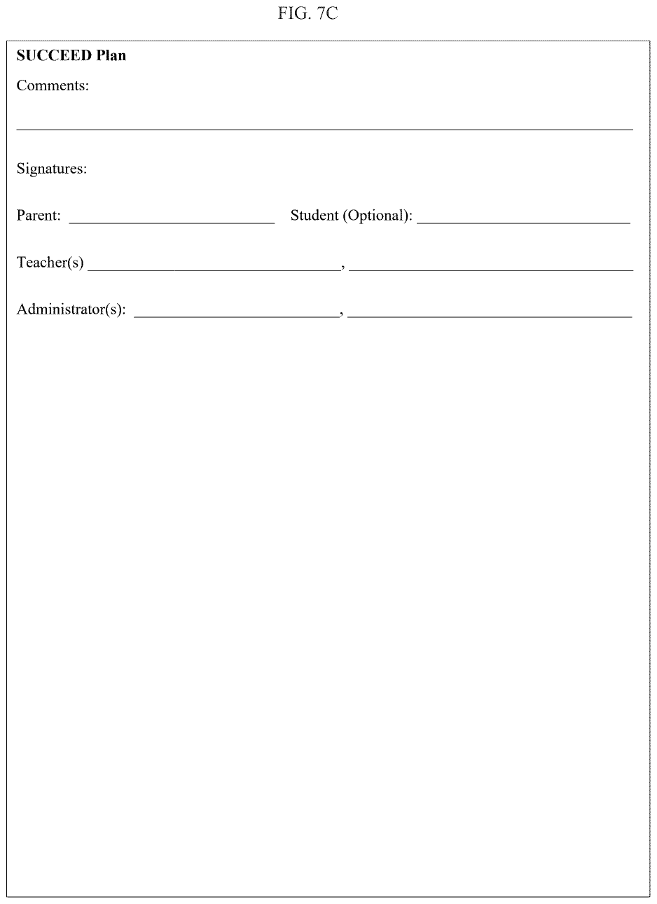

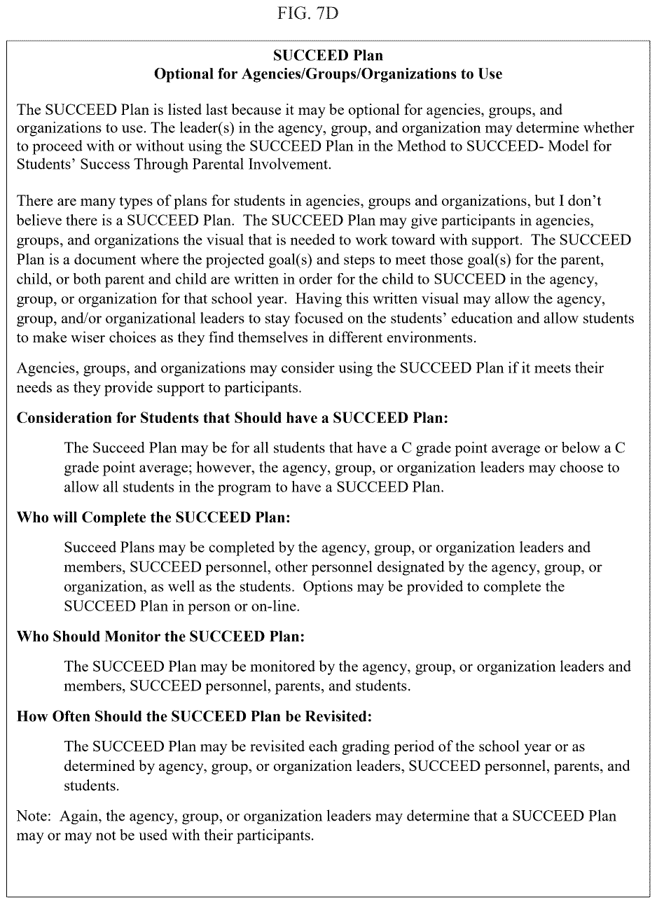

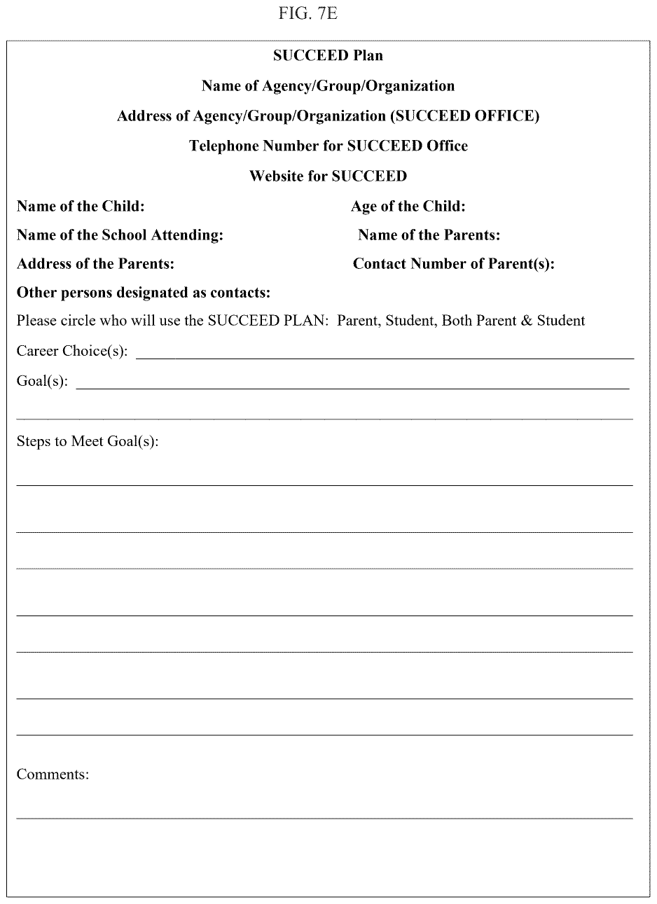

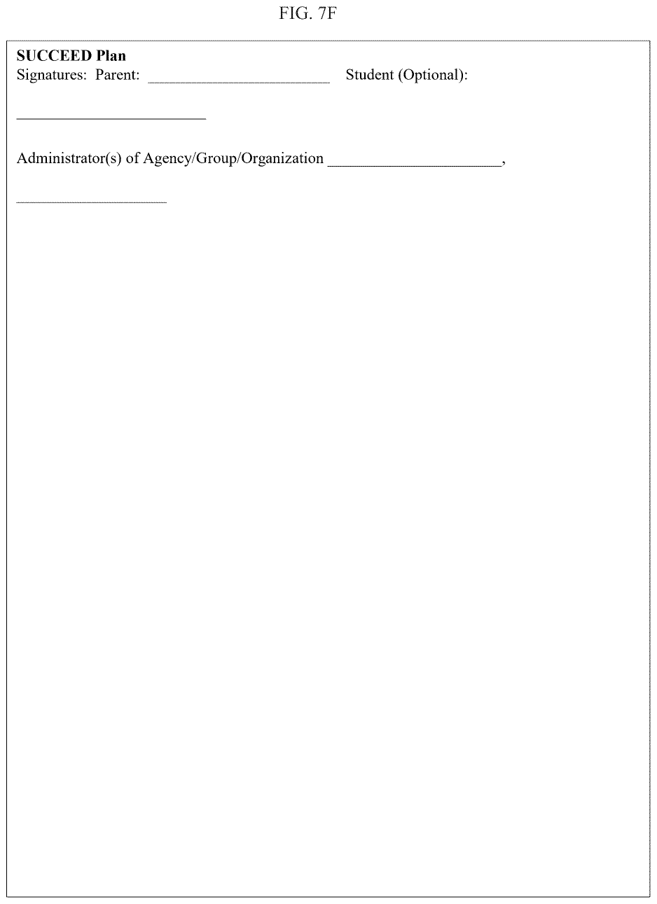

The SUCCEED Plan/Document for parents, school personnel, and the school community 7A-7C to use is illustrated in FIG. 7.

The SUCCEED Plan/Document for agencies, groups and organizations 7D-7F to use is illustrated in FIG. 7.

### Monthly Awards

### Awards: SUCCEED Parent (Monthly)

SUCCEED Parent of the Month or SUCCEED Top Parent of the Month (Consider adding additional parent awards to include more parents. The additional awards may be SUCCEED 1^{st} Place Parent of the Month, SUCCEED 2^{nd} Place Parent of the Month, SUCCEED 3^{rd} Place Parent of the Month, and SUCCEED Honorable Mention Parent of the Month).

### Participant Selection Determined By

The selection of SUCCEED Parent of the Month or SUCCEED Top Parent of the Month (SUCCEED 1^{st} Place Parent of the Month, SUCCEED 2^{nd} Place Parent of the Month, SUCCEED 3^{rd} Place Parent of the Month, and SUCCEED Honorable Mention Parent of the Month) may be determined each month by teachers at each school and central office personnel.

### Criteria for Selecting SUCCEED Parent of the Month Award or SUCCEED Top Parent of the Month (SUCCEED 1^{st} Place Parent of the Month, SUCCEED 2^{nd} Place Parent of the Month, SUCCEED 3^{rd} Place Parent of the Month, and SUCCEED Honorable Mention Parent of the Month) May Include

Parent attended all school meetings.

Child improved in attendance.

Child improved with behavior.

Child improved academically.

Child goes the extra mile to learn and succeed.

Optional: Child participated in extracurricular activity(ies).

If the options for SUCCEED 1^{st} Place Parent of the Month, SUCCEED 2^{nd} Place Parent of the Month, SUCCEED 3^{rd} Place Parent for the Month, and SUCCEED Honorable Mention Parent of the Month are used, the criteria for selecting these parents may be to the degree that some improvement was made with the parent attending school meetings, and the child improved to some degree in attendance, behavior, and academically. Participation in extracurricular activities may not be considered as optional.

### Awards/Gifts for SUCCEED Parent of the Month or SUCCEED Top Parent of the Month May Include

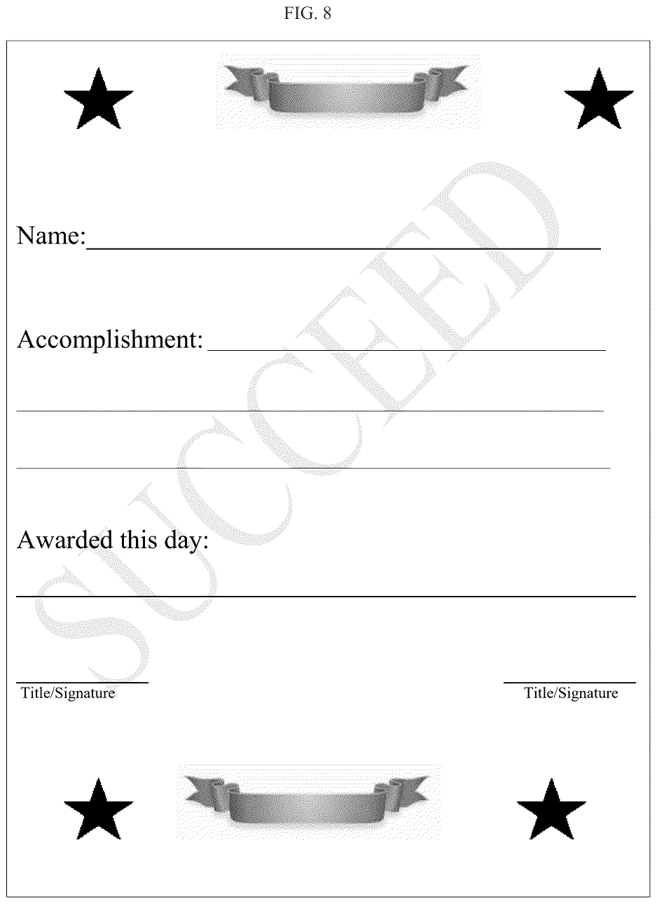

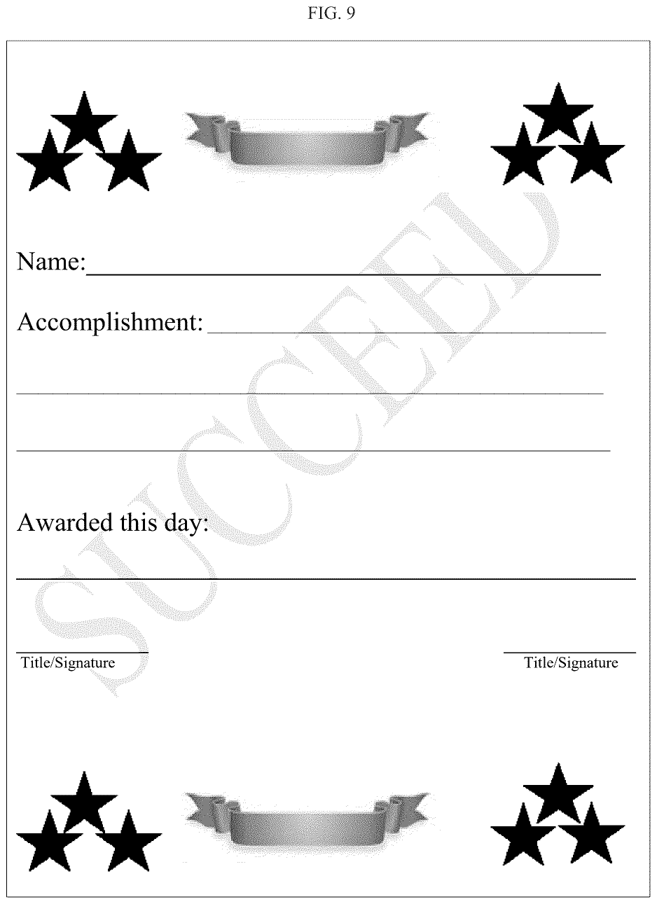

Certificate as seen in FIGS. 8, 9, or 10/Plaque
Some Type of Gift
Monetary Award
Recognition through media at the school level and district levels
Recognition in written posted form at the school level and district levels
Newspaper Recognition
Recognition through approved forms of media

If the options for SUCCEED 1^{st} Place Parent of the Month, SUCCEED 2^{nd} Place Parent of the Month, SUCCEED 3^{rd} Place Parent for the Month, and SUCCEED Honorable Mention Parent of the Month are used, these parents may receive to a lesser degree of a gift and monetary award and the same degree of receiving a certificate, and recognition at the school and district levels as well as recognition through all forms of approved media to include the newspaper. A plaque will not be awarded to these parents.

### Awards: SUCCEED Student (Monthly)

SUCCEED Student of the Month or SUCCEED Top Student of the Month (Consider adding additional student awards to include more students. The additional awards may be SUCCEED 1^{st} Place Student of the Month, SUCCEED 2^{nd} Place Student of the Month, SUCCEED 3^{rd} Place Student of the Month, and SUCCEED Honorable Mention Student of the Month).

### Participant Selection Determined By

The selection of SUCCEED Student of the Month or SUCCEED Top Student of the Month (SUCCEED 1^{st} Place Student of the Month, SUCCEED 2^{nd} Place Student of the Month, SUCCEED 3^{rd} Place Student of the Month, and SUCCEED Honorable Mention Student of the Month) may be determined each month by teachers at each school and central office personnel.

### Criteria for Selecting SUCCEED Student of the Month Award or SUCCEED Top Student of the Month (SUCCEED 1^{st} Place Student of the Month, SUCCEED 2^{nd} Place Student of the Month, SUCCEED 3^{rd} Place Student of the Month, and SUCCEED Honorable Mention Student of the Month) May Include

Child improved in attendance.

Child improved with behavior.

Child improved academically.

Child goes the extra mile to learn and succeed.

Optional: Child participated in extracurricular activity(ies).

### Awards/Gifts for SUCCEED Student of the Month or SUCCEED Top Student of the Month May include

Certificate/Plaque
Some Type of Gift
Monetary Award
Recognition through media at the school level and district levels
Recognition in written posted form at the school level and district levels
Newspaper Recognition
Recognition through approved forms of media

If the options for SUCCEED 1^{st} Place Student of the Month, SUCCEED 2^{nd} Place Student of the Month, SUCCEED 3^{rd} Place Student for the Month, and SUCCEED

Honorable Mention Student of the Month are used, these students may receive to a lesser degree of a gift and monetary award and the same degree of receiving a certificate, and recognition at the school and district levels as well as recognition through all forms of approved media to include the newspaper. A plaque will not be awarded to these students.

### Awards: SUCCEED Volunteers (Monthly)

SUCCEED Volunteer of the Month or SUCCEED Top Volunteer of the Month (Consider adding additional volunteer awards to include more volunteers. The additional awards may be SUCCEED 1^{st} Place Volunteer of the Month, SUCCEED 2^{nd} Place Volunteer of the Month, SUCCEED 3^{rd} Place Volunteer of the Month, and SUCCEED Honorable Mention Volunteer of the Month).

### Participant Selection Determined By

The selection of SUCCEED Volunteer of the Month or SUCCEED Top Volunteer of the Month (SUCCEED 1^{st} Place Volunteer of the Month, SUCCEED 2^{nd} Place Volunteer of the Month, SUCCEED 3^{rd} Place Volunteer of the Month, and SUCCEED Honorable Mention Volunteer of the Month) may be determined each month by teachers at each school and central office personnel.

### Criteria for Selecting SUCCEED Volunteer of the Month or SUCCEED Top Volunteer of the Month (SUCCEED 1^{st} Place Volunteer of the Month, SUCCEED 2^{nd} Place Volunteer of the Month, SUCCEED 3^{rd} Place Volunteer of the Month, and SUCCEED Honorable Mention Volunteer of the Month) May Include

Vast improvement with student(s) receiving assistance.

Number of hours volunteered.

Number of students assisted

### Awards/Gifts for SUCCEED Volunteer of the Month or SUCCEED Top Volunteer of the Month May Include

Certificate/Plaque
Some Type of Gift
Monetary Award
Recognition through media at the school level and district levels
Recognition in written posted form at the school level and district levels
Newspaper Recognition
Recognition through approved forms of media

If the options for SUCCEED 1^{st} Place Volunteer of the Month, SUCCEED 2^{nd} Place Volunteer of the Month, SUCCEED 3^{rd} Place Volunteer of the Month, and SUCCEED Honorable Mention Volunteer of the Month are used, these volunteers may receive to a lesser degree of a gift and monetary award and the same degree of receiving a certificate, and recognition at the school and district levels as well as recognition through all forms of approved media to include the newspaper. A plaque will not be awarded to these volunteers.

### Awards: SUCCEED Stakeholders (Monthly)

Keep in mind that stakeholders may wish to remain anonymous.

SUCCEED Stakeholder of the Month or SUCCEED Top Stakeholder of the Month (Consider adding additional stakeholder awards to include more stakeholders. The additional awards may be SUCCEED 1^{st} Place Stakeholder of the Month, SUCCEED 2^{nd} Place Stakeholder of the Month, SUCCEED 3^{rd} Place Stakeholder of the Month, and SUCCEED Honorable Mention Stakeholder of the Month).

### Participant Selection Determined By

The selection of SUCCEED Stakeholder of the Month or SUCCEED Top Stakeholder of the Month (SUCCEED 1^{st} Place Stakeholder of the Month, SUCCEED 2^{nd} Place Stakeholder of the Month, SUCCEED 3^{rd} Place Stakeholder of the Month, and SUCCEED Honorable Mention Stakeholder of the Month) may be determined each month by teachers from each school and central office personnel.

### Criteria for Selecting SUCCEED Stakeholder of the Month or SUCCEED Top Stakeholder of the Month (SUCCEED 1^{st} Place Stakeholder of the Month, SUCCEED 2^{nd} Place Stakeholder of the Month, SUCCEED 3^{rd} Place Stakeholder of the Month, and SUCCEED Honorable Mention Stakeholder of the Month) May Include

Considerable donation of time to SUCCEED student(s).

Considerable donation of funds to SUCCEED program.

### Awards/Gifts for SUCCEED Stakeholder of the Month or SUCCEED Top Stakeholder of the Month May Include

Certificate/Plaque
Some Type of Gift
Recognition through media at the school level and district levels
Recognition in written posted form at the school level and district levels
Newspaper recognition
Recognition through approved forms of media

If the options for SUCCEED 1^{st} Place Stakeholder of the Month, SUCCEED 2^{nd} Place Stakeholder of the Month, SUCCEED 3^{rd} Place Stakeholder of the Month, and SUCCEED Honorable Mention Stakeholder of the Month are used, these stakeholders may receive to a lesser degree of a gift and plaque with the same degree of receiving a certificate, and recognition at the school and district levels as well as recognition through all forms of approved media to include the newspaper.

Any parent, student, volunteer, or stakeholder that does not want to receive any type of recognition for participation in SUCCEED should inform in writing a designated central office school personnel employee once the decision has been made. Should parents, students, volunteers, or stakeholders change their mind about receiving any type of recognition, simply inform the same contact about their preference to participate.

### End of the School Year SUCCEED Banquet

### Purpose of End of the School Year SUCCEED Banquet

To recognize SUCCEED Parent of the Month or SUCCEED Top Parent of the Month, SUCCEED Student of the Month or SUCCEED Top Student of the Month, SUCCEED Volunteer of the Month or SUCCEED Top Volunteer of the Month, SUCCEED Stakeholder of the Month or SUCCEED Top Stakeholder of the Month for each month of that particular school year and for each school in the district. If SUCCEED 1^{st}, 2^{nd}, 3^{rd} place, and Honorable Mention A wards are presented monthly during the school year to parents, students, volunteers, and stakeholders, these participants will be recognized as well at the end of the school year banquet.

To announce the SUCCEED Parent of the Year or SUCCEED Top Parent of the Year, SUCCEED Student of the Year or SUCCEED Top Student of the Year, SUCCEED Volunteer of the Year or SUCCEED Top Volunteer of the Year, and SUCCEED Stakeholder of the year or SUCCEED Top Stakeholder of the Year for the school district. Present SUCCEED 1^{st}, 2^{nd}, 3^{rd} place, and Honorable Mention A wards of the Year to parents, students, volunteers, and stakeholders if it was decided that these awards were awarded monthly by the school district.

To recognize the first SUCCEED parent participant of that particular school year.

To recognize the first student to receive assistance through SUCCEED for that particular school year. To the extent possible the first student should be in relation to the first parent to seek and receive service from SUCCEED for that particular school year.

To recognize all parents that participated in SUCCEED during that particular school year.

To recognize all students that participated in SUCCEED during that particular school year.

To recognize all Drop-In parents and students that do not wish to remain anonymous.

### Awards: SUCCEED Parents (End of the Year Banquet)

SUCCEED Parent of the Year or SUCCEED Top Parent of the Year (Consider the option to awarding SUCCEED 1^{st} Place Parent of the Year, SUCCEED 2^{nd} Place Parent of the Year, SUCCEED 3^{rd} Place Parent for the Year, and SUCCEED Honorable Mention Parent of the Year to include more parents).

### Selection of SUCCEED Parent of the Year or SUCCEED Top Parent of the Year (SUCCEED 1^{st} Place Parent of the Year SUCCEED 2^{nd} Place Parent of the Year, SUCCEED 3^{rd} Place Parent of the Year, and SUCCEED Honorable Mention Parent of the Year)

The selection of SUCCEED Parent of the Year or SUCCEED Top Parent of the Year, (Consider SUCCEED 1^{st} Place Parent of the Year SUCCEED 2^{nd} Place Parent of the Year, SUCCEED 3^{rd} Place Parent of the Year, and SUCCEED Honorable Mention Parent of the Year) may be determined by teachers from each school in the district and central office staff.

### Criteria for Selecting Succeed Parent of the Year or Top Parent of the Year (SUCCEED 1^{st} Place Parent of the Year, SUCCEED 2^{nd} Place Parent of the Year, SUCCEED 3^{rd} Place Parent for the Year, and SUCCEED Honorable Mention Parent of the Year)

Parent attended all school meetings.

Child improved in attendance.

Child improved with behavior.

Child improved academically.

Child goes the extra mile to learn and succeed.

Optional: Child participated in extracurricular activity(ies).

### Awards/Gifts for SUCCEED Parent of the Year of SUCCEED Top Parent of the Year

Plaque
Some type of Gift
Monetary Award
Recognition through media at the school level and district levels
Recognition in written posted form at the school level and district levels
Newspaper Recognition
Recognition through approved forms of media

If the options for SUCCEED 1^{st} Place Parent of the Year, SUCCEED 2^{nd} Place Parent of the Year, SUCCEED 3^{rd} Place Parent for the Year, and SUCCEED Honorable Mention Parent of the Year are used, these parents may receive to a lesser degree of a gift and monetary award with the same degree of receiving a certificate, and recognition at the school and district levels as well as recognition through all forms of approved media to include the newspaper. A plaque will not be awarded to these parents.

First parent to seek and receive services for that particular school year may be asked to stand and receive a certificate.

All previous SUCCEED Parent of the Month or SUCCEED Top Parent of the Month for each month of that particular school year may be asked to stand.

All parents that participated in SUCCEED for that particular school year may be asked to stand and receive a certificate.

### Awards: SUCCEED Students (End of the Year)

To recognize SUCCEED Student of the Year or SUCCEED Top Student of the Year (Consider the option to award SUCCEED 1^{st} Place Student of the Year, SUCCEED 2^{nd} Place Student of the Year, SUCCEED 3^{rd} Place Student of the Year, and SUCCEED Honorable Mention Student of the Year to include more students).

### Selection of SUCCEED Student of the Year or SUCCEED Top Student of the Year (SUCCEED 1^{st} Place Student of the Year, SUCCEED 2^{nd} Place Student of the Year, SUCCEED 3^{rd} Place Student of the Year, and SUCCEED Honorable Mention Student of the Year)

The selection of SUCCEED Student of the Year or SUCCEED Top Student of the Year (SUCCEED 1^{st} Place Student of the Year, SUCCEED 2^{nd} Place Student of the Year, SUCCEED 3^{rd} Place Student of the Year, and SUCCEED Honorable Mention Student of the Year) may be determined by teachers at each school in the district and central office personnel.

### Criteria for Selecting Succeed Student of the Year Award or Top Succeed Student of the Year (SUCCEED 1^{st} Place Student of the Year, SUCCEED 2^{nd} Place Student of the Year, SUCCEED 3^{rd} Place Student of the Year, and SUCCEED Honorable Mention Student of the Year) May Include

Child improved in attendance

Child improved with behavior.

Child improved academically.

Child going the extra mile to learn and succeed.

Optional: Child participated in extracurricular activity(ies).

If the options for SUCCEED 1^{st} Place Student of the Year, SUCCEED 2^{nd} Place Student of the Year, SUCCEED 3^{rd} Place Student for the Year, and SUCCEED Honorable Mention Student of the Year are used, the criteria for selecting these students may be to the degree that some improvement was made with the student attending school, and the child improved to some degree in attendance, behavior, and academically. Participation in extracurricular activities may be considered optional.

### Awards/Gifts for SUCCEED Student of the Year Award or SUCCEED Top Student of the Year May Include

Certificate/Plaque
Some Type of Gift
Monetary Award
Recognition through media at the school level and district levels
Recognition in written posted form at the school level and district levels
Newspaper Recognition
Recognition through approved forms of media

If the options for SUCCEED 1^{st} Place Student of the Year, SUCCEED 2^{nd} Place Student of the Year, SUCCEED 3^{rd} Place Student for the Year and SUCCEED Honorable Mention Student of the Year are used, these students would receive to a lesser degree of a gift and monetary award and the same degree of receiving a certificate, and recognition at the school and district levels, as well as recognition through all forms of approved media to include the newspaper. A plaque will not be awarded to these students.

The first student to receive assistance through SUCCEED for that particular school year may be asked to stand and receive a certificate. To the extent possible the first student should be in relation to the first parent to seek and receive service from SUCCEED for that particular school year.

All students that participated in the SUCCEED Program will be asked to stand and receive a certificate.

All SUCCEED students recognized monthly as Students of the Month or SUCCEED Top Student of the Month (SUCCEED 1^{st} Place Student of the Month, SUCCEED 2^{nd} Place Student of the Month, SUCCEED 3^{rd} Place Student of the Month, and SUCCEED Honorable Mention Student of the Month) for that particular school year may be asked to stand.

### Awards: SUCCEED Volunteers (End of the Year)

To recognize the SUCCEED Volunteer of the Year or SUCCEED Top Volunteer of the Year at the end of the school year (Consider awarding SUCCEED 1^{st} Place Volunteer of the Year, SUCCEED 2^{nd} Place Volunteer of the Year, SUCCEED 3^{rd} Place Volunteer for the Year, and SUCCEED Honorable Mention Volunteer of the Year to include more volunteers).

### Selection of Succeed Volunteer of the Year or Succeed Top Volunteer of the Year (SUCCEED 1^{st} Place Volunteer of the Year, SUCCEED 2^{nd} Place Volunteer of the Year, SUCCEED 3^{rd} Place Volunteer for the Year, and SUCCEED Honorable Mention Volunteer of the Year)

The selection of SUCCEED Volunteer of the Year or SUCCEED Top Volunteer of the Year (SUCCEED 1^{st} Place Volunteer of the Year, SUCCEED 2^{nd} Place Volunteer of the Year, SUCCEED 3^{rd} Place Volunteer for the Year, and SUCCEED Honorable Mention Volunteer of the Year) may be determined by teachers from each school in the district and central office personnel.

### Criteria for selecting SUCCEED Volunteer of the Year or SUCCEED Top Volunteer of the Year (SUCCEED 1^{st} Place Volunteer of the Year, SUCCEED 2^{nd} Place Volunteer of the Year, SUCCEED 3^{rd} Place Volunteer for the Year, and SUCCEED Honorable Mention Volunteer of the Year)

Vast improvement with student(s) receiving assistance.

Number of hours volunteered.

Number of students assisted

### Awards/Gifts for SUCCEED Volunteer of the Year of SUCCEED Top Volunteer of the Year May Include

Certificate/Plaque
Some type of Gift
Monetary Award
Recognition through media at the school level and district levels
Recognition in written posted form at the school level and district levels
Newspaper Recognition
Recognition through approved forms of media

If the options for SUCCEED 1^{st} Place Volunteer of the Year, SUCCEED 2^{nd} Place Volunteer of the Year, SUCCEED 3^{rd} Place Volunteer of the Year, and SUCCEED Honorable Mention Volunteer of the Year are used, these volunteers may receive to a lesser degree of a gift and monetary award and the same degree of receiving a certificate, and recognition at the school and district levels as well as all forms of approved media to include the newspaper. A plaque will not be awarded to these volunteers.

All previous volunteers that were awarded SUCCEED Volunteer of the Month or SUCCEED Top Volunteer of the Month (SUCCEED 1^{st} Place Volunteer of the Month SUCCEED 2^{nd} Place o Volunteer of the Month, SUCCEED 3^{rd} Place Volunteer of the Month, and SUCCEED Honorable Mention Volunteer of the Month for that particular school year may be asked to stand.

All volunteers in SUCCEED may be asked to stand and receive a certificate.

### Awards: SUCCEED Stakeholders (End of Year)

Keep in mind that stakeholders may wish to remain anonymous.

To announce SUCCEED Stakeholder of the Year, SUCCEED Stakeholder of the Year or SUCCEED Top Stakeholder of the Year, (Consider awarding SUCCEED 1^{st} Place Stakeholder of the Year, SUCCEED 2^{nd} Place Stakeholder of the Year, SUCCEED 3^{rd} Place Stakeholder of the Year, and SUCCEED Honorable Mention Stakeholder of the Year to include more stakeholders).

### Selection of SUCCEED Stakeholder of the Year or SUCCEED Top Stakeholder of the Year (SUCCEED 1^{st} Place Stakeholder of the Year, SUCCEED 2^{nd} Place Stakeholder of the Year, SUCCEED 3^{rd} Place Stakeholder of the Year, and SUCCEED Honorable Mention Stakeholder of the Year)

The selection of SUCCEED Stakeholder of the Year or SUCCEED Top Stakeholder of the Year (SUCCEED 1^{st} Place Stakeholder of the Year, SUCCEED 2^{nd} Place Stakeholder of the Year, SUCCEED 3^{rd} Place Stakeholder of the Year, and SUCCEED Honorable Mention Stakeholder of the Year) may be determined by teachers at each school in the district and central office personnel.

### Criteria for Selecting Succeed Stakeholder of the Year or Top Succeed Stakeholder of the Year (SUCCEED 1^{st} Place Stakeholder of the Year, SUCCEED 2^{nd} Place Stakeholder of the Year, SUCCEED 3^{rd} Place Stakeholder of the Year, and SUCCEED Honorable Mention Stakeholder of the Year)

Considerable donation of time to SUCCEED student(s)

Considerable donation of funds to SUCCEED program

### Awards/Gifts for SUCCEED Stakeholder of the Year or SUCCEED Top Stakeholder of the Year May Include

Certificate/Plaque
Some Type of Gift
Recognition through media at the school level and district levels
Recognition in written posted form at the school level and district levels
Newspaper Recognition
Recognition through approved forms of media

If the options for SUCCEED 1^{st} Place Stakeholder of the Year, SUCCEED 2^{nd} Place Stakeholder of the Year, SUCCEED 3^{rd} Place Stakeholder of the Year, and SUCCEED Honorable Mention Stakeholder of the Year are used, these stakeholders may receive to a lesser degree of a gift and plaque with the same degree of receiving a certificate, and recognition at the school and district levels as well as recognition through all forms of approved media to include the newspaper.

All previous SUCCEED Stakeholders of the Month or all previous Top SUCCEED Stakeholders of the Month (SUCCEED 1^{st} Place Stakeholder of the Month, SUCCEED 2^{nd} Place Stakeholder of the Month, SUCCEED 3^{rd} Place Stakeholder of the Month, and SUCCEED Honorable Mention Stakeholder) for that particular school year may be asked to stand.

All previous stakeholders for that particular school year will be recognized by being asked to stand and receive a certificate.

### Award: SUCCEED Drop-In Award: (End of Year)

Drop-In participants may asked to stand to receive a SUCCEED Drop-In Certificate for participation in the program at the banquet. If parents or students that have participated in Drop-In would like to remain anonymous, that option will be provided. The Drop-In participants would need to notify in writing the designated personnel at the central office that they do not want to participate in the end of the year banquet.

### All SUCCEED End of the Year Banquet Award Participants

Recipients of awards will be encouraged to participate in the SUCCEED End of the Year Banquet and invite their family and friends as well. All potential participants that do not wish to participate in the SUCCEED End of the Year Banquet may inform designated school personnel in writing at the central office concerning their desire not to participate.

### Publicity

This banquet may be covered by all forms of media. Pictures of all participants may be taken physically and electronically for each school as well as for the central office. A scrapbook entitled, Davis Model for School Success through Parental Involvement may be made electronically and physically for each school and for the central office on a yearly basis.

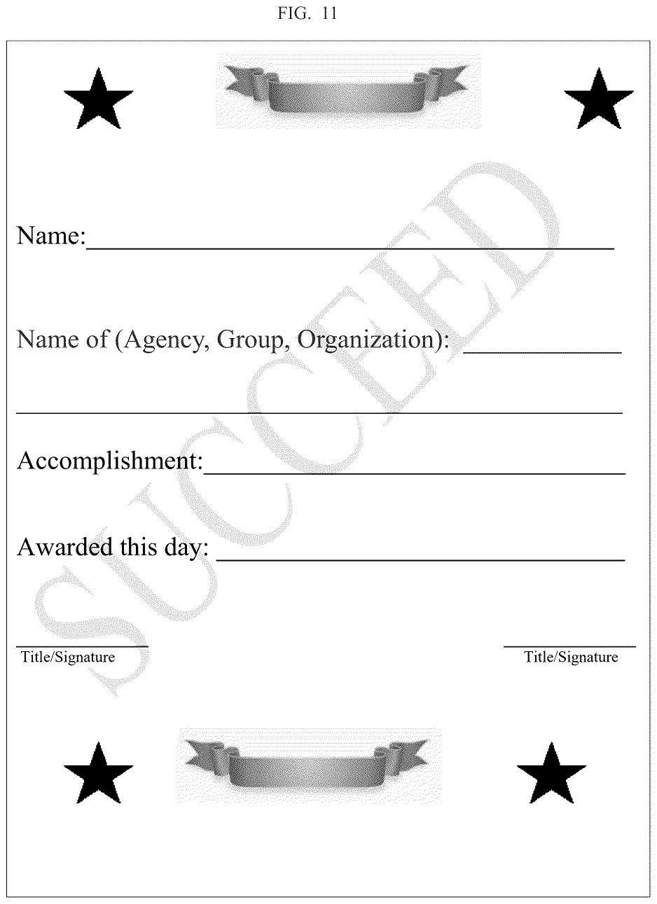

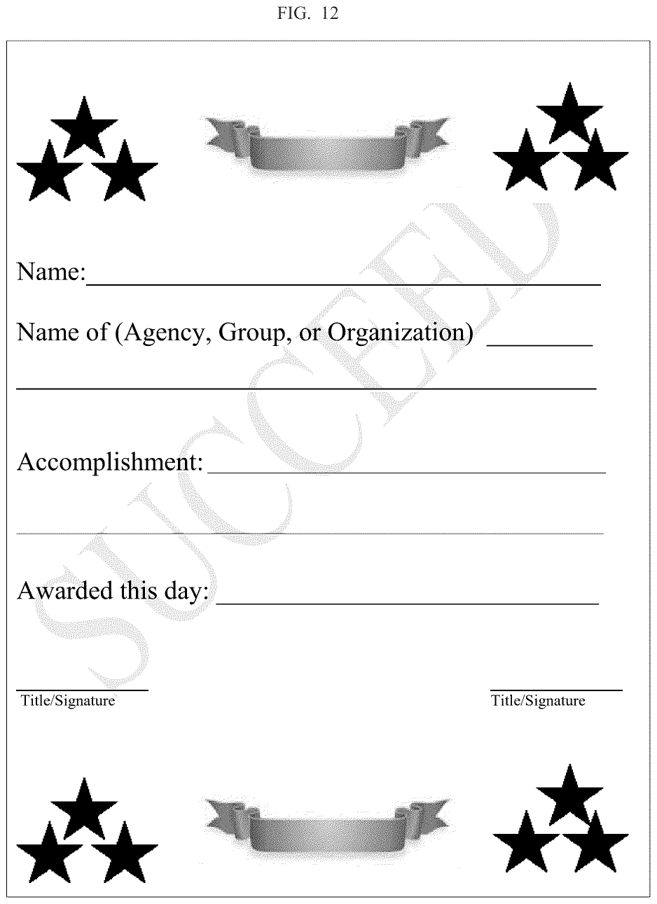

Monthly and yearly criteria for schools will be used for agencies, groups and organizations to receive the award of a certificate as shown in FIGS. 11, 12, or 13.

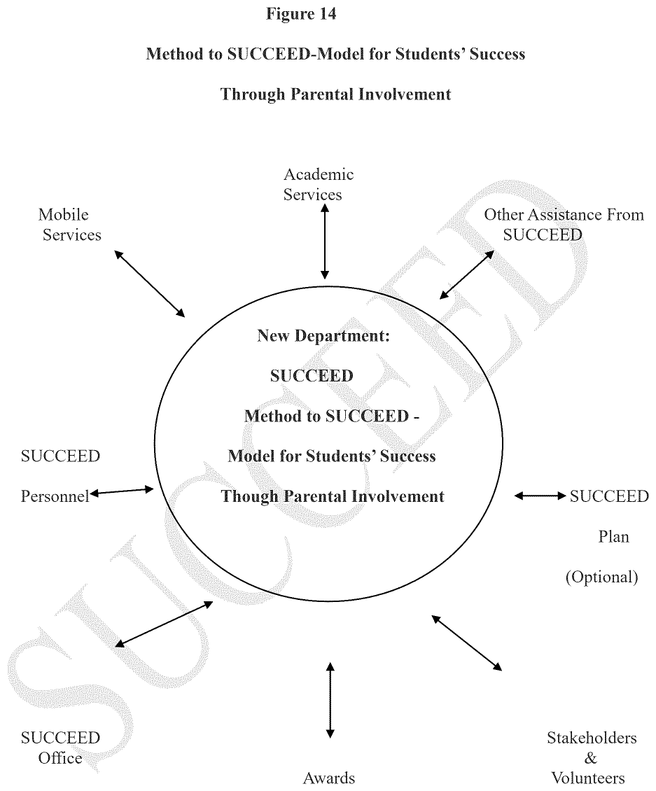

A Model illustrating the components of Model to SUCCEED for Students' Success Through Parental Involvement is shown in FIG. 14.

I claim:

1. A method of providing an educational model, system, instruction, and institution with a system of providing support to parents through a manual comprising the step of: instructing parents to improve participation in their child's education/activities to increase students' performance through the steps of informing participants about SUCCEED, and awarding successful participants of SUCCEED.

2. The method according to claim 1 further including a step of writing a letter with a checklist to parents of students in school to determine the needs of parents through Method to SUCCEED—Model for Students' Success Through Parental Involvement.

3. The method according to claim 1 further including a step of writing a letter with a checklist and questions to parents of students in school to determine the needs of parents through Method to SUCCEED—Model for Students' Success Through Parental Involvement.

4. The method according to claim 1 further including a step of writing a letter with a checklist to parents of students in agencies, groups, and organizations to determine the needs of parents through Method to SUCCEED—Model for Students' Success Through Parental Involvement.

5. The method according to claim 1 further including a step of writing a letter with checklist and questions to parents of students in agencies, groups, and organizations to determine the needs of parents through Method to SUCCEED—Model for Students' Success Through Parental Involvement.

6. The method according to claim 1 further including a step of providing assistance with homework through the Homework and Classwork Division of Method to SUCCEED—Model for Students' Success Through Parental Involvement includes reserving blocks of time using software on a computer to receive assistance with homework.

7. The method according to claim 1 further including a step of providing counseling to parents for their child to stay in school as well as providing counseling to the child to stay in school includes dropping in to discuss this matter or reserving appointment with SUCCEED personnel, Drop-In Division.

8. The method according to claim 1 further including a step of providing a SUCCEED Plan for parents and students through Method to SUCCEED—Model for Students' Success Through Parental Involvement.

9. The method according to claim 1 further including a step of providing a SUCCEED Pan Form consisting of noting career choices, goals, and steps to meet goals for parents and students through Method to succeed—model for Students' Success Through Parental Involvement.

10. The method according to claim 1 further including a step of awarding a first, second, or third certificate to parents in schools, agencies, groups, and organizations upon the parents attending all meetings, student improving in attendance, student improving with behavior, student improving academically, physically, or emotionally as well as student going the extra mile to learn and succeed; then awarding a certificate to parents.

11. The method according to claim 1 further including a step of awarding a first, second or third certificate to students in schools, agencies, groups, and organizations upon the students improving in attendance, improving behavior, improving academically, and going the extra mile to learn and succeed; then awarding a certificate to students.

12. The method according to claim 1 further including a step of awarding a first, second, or third certificate to volunteers in schools, agencies, groups, and organizations upon the volunteers contributing vastly to improve students' performance, calculating numbers of hours volunteered, and numbering of students assisted; then awarding a certificate to volunteers.

13. The method according to claim 1 further including a step of awarding a first, second, or third certificate to stakeholders that support schools, agencies, groups, and organizations upon the stakeholders contributing considerable donation of time to SUCCEED students, and giving a considerable donation of funds to SUCCEED; then awarding a certificate to stakeholders.
